(19) United States
(12) Patent Application Publication
(10) Pub. No.: US 2018/0153186 A1
(43) Pub. Date: Jun. 7, 2018

(54) Powdered Cheese Method and Product

(71) Applicants: Jessilee Loucks, Twin Falls, ID (US); Daniel B. Clayton, Filer, ID (US); David B. Perry, Twin Falls, ID (US)

(72) Inventors: Jessilee Loucks, Twin Falls, ID (US); Daniel B. Clayton, Filer, ID (US); David B. Perry, Twin Falls, ID (US)

(21) Appl. No.: 15/832,741

(22) Filed: Dec. 5, 2017

Related U.S. Application Data
(60) Provisional application No. 62/430,064, filed on Dec. 5, 2016.

(51) Int. Cl. A23C 19/086; A23C 19/097

(52) U.S. Cl. CPC A23C 19/086; A23C 19/0976

(57) ABSTRACT

Disclosed is a method for making cheese powder using freeze-dried cheese, the method eliminating the need for added emulsifying salts. Also disclosed are products made by the method.

### FIELD OF THE INVENTION

The invention relates to dried, powdered dairy products. More specifically, the invention relates to methods for producing powdered cheeses and products made by those methods.

### BACKGROUND OF THE INVENTION

Billions of dollars each year are spent on boxed macaroni and cheese, cheese puffs, and a multitude of nacho cheese-flavored snacks. Cheese powder is used in dips, dressings, crackers, sauces, chips and as a flavoring to be sprinkled on foods such as spaghetti and soups. Although other ingredients are included in the “cheese powder” components of these products, powdered cheese does actually comprise a significant portion of most cheese powder products. Cheese powders are therefore a food service staple and flavoring ingredient, especially in the snack market.

Although available in its more basic forms years earlier, a spray-drying method was first patented in the United States by Samuel R. Percy in 1872 (U.S. Pat. No. 125,406). According to the patent specification, the objective was to prepare a product that was “dried quickly and brought into a state of minute division, and may thus be protected from destructive chemical changes,” However, it would be years later when the method was applied to cheese.

Powdered dried cheese was available to soldiers during the Second World War, and industrial production of cheese powders began in the 1950s. Today, the production of cheese powder is a process that is carried out around the world, and is primarily done by spray-drying a cheese slurry to form a powdered product. In order to spray-dry cheese it is necessary to bring it to a liquid form. This can be done by a melting process where the cheese rind, if any, is removed, the cheese is disintegrated (i.e., broken into smaller parts), then, during heating and agitation, melting salts such as phosphates and citrates are added, along with water. The aim is to obtain a solids content of about 35% and a temperature of 75° C. in order to get a feed which is not too viscous for atomization. In commercial cheese powder production, cheese is comminuted and melted, with the addition of water and emulsifying salts. Emulsifying salts, primarily sodium phosphate, are added to create an emulsion that remains stable until spray drying and also to ensure a final powder with good shelf stability. This produces a cheese slurry, or cheese feed, which is heat-treated. Most of the water is then removed by spray drying—e.g., the liquid cheese is sprayed through an atomizer to convert liquid to droplets which are blasted with hot air to create a cheese powder. However, cheese powder produced by this method often contains more additives (such as whey, vegetable oil, various sodium-containing compounds, and dyes) than cheese.

According to the United States Food and Drug Administration (http://www.fda.gov), “[t]he majority of sodium consumed comes from processed and prepared foods, not the salt shaker. This makes it difficult for all of us to control how much sodium we consume. Some companies have reduced sodium in certain foods, but many foods continue to contribute to high sodium intake, especially processed and prepared foods.” Many of these foods contain cheese powders. Even though some emulsifying salts are used only as processing aids, the emulsifying salts that are added to facilitate the spray-drying process remain with the final powdered cheese product, thereby increasing the sodium content. The addition of salt is a necessary step in commercial cheese production, and part of the desirable taste of various cheese powders is due to the salty taste that is associated with them, so entirely eliminating salt from powdered cheese products is not desirable. However, since cheese powders are a part of such a vast array of both fresh and processed foods, it would be beneficial to find ways to maintain the taste while reducing the sodium content of these powders.

Table 1 lists ingredients found in a variety of commercially-available cheese powders. Sources of added sodium (i.e., in addition to the salt used to produce the natural cheese) are indicated in bold print.

TABLE 1
Ingredients Listing-Commercially-Available Cheese Powders

| | Total Sodium |
|---|---|
| | (mg/28 g |
| Ingredients | powder |
| (Sources of Added Sodium Indicated in Bold Print) | product) |
| Whey (milk), Buttermilk, Corn Syrup Solids, Modified Food Starch (corn), Salt, | 428 |
| Dry Shortening (partially hydrogenated soybean oil, corn syrup solids, | |
| sodium caseinate (milk)), Cheddar & Romano Cheese (milk)(Cultured | |
| Pasteurized Milk, Salt, Enzymes), Sodium Phosphate, Silicon Dioxide (anti- | |
| caking agent), Corn Starch, Natural Flavor, Partially Hydrogenated Soybean | |
| oil, Turmeric Extract, Citric Acid, Lactic Acid and Annatto Extract | |
| Cheddar cheese (milk, salt, cultures, & enzymes), and disodium phosphate. | 564 |
| May contain sodium silico aluminate at <2%. | |
| Cheese Powder (Whey, Buttermilk Solids, Cheeses [Granular And Cheddar | 675 |
| {Pasteurized Milk, Cheese Culture, Salt, Enzymes}], Whey Protein Concentrate, | |
| Salt, Sodium Phosphate, Citric Acid, FD&C Yellow #5, FD&C Yellow #6, Lactic | |
| Acid, Enzymes), Modified Corn Starch, Creamer (Maltodextrin, Palm Oil), | |
| Silicon Dioxide. | |
| Whey Powder, Modified Food Starch, Cheddar Cheese (Milk, Cultures, Salt & | 850 |
| Enzymes), Maltodextrin, Salt, Natural Flavors, Sodium Phosphates, Partially | |
| Hydrogenated Soybean Oil, Buttermilk, Yeast Extract, Sodium Alginate, | |
| Xanthan Gum, Silicon Dioxide (flow agent), Yellow #5 and #6. | |
| A Dehydrated Blend of Cheese (granular and blue (pasteurized milk, cheese | 1008 |
| culture, salt, enzymes)), Whey, Partially Hydrogenated Soybean Oil, Whey | |
| Protein Concentrate, Lactose, Maltodextrin, Salt, Sodium Phosphate, Citric | |
| Acid, Lactic Acid, Yellow 5, Yellow 6 | |
| Cheddar Cheese (Milk, Salt, Cheese Cultures, & Enzymes), Whey, Buttermilk, | 1070 |
| Salt, Disodium Phosphate, Annatto Extract | |
| Vermont Cheddar Cheese (Cultured Milk, Salt, Enzymes), Cheddar Cheese | 1220 |
| (Cultured Pasteurized Milk, Salt, Enzymes), Whey, Buttermilk, Salt, Disodium | |
| Phosphate | |
| Organic Cheddar cheese (Organic pasteurized milk, salt, cheese cultures, | 1250 |
| enzymes), organic tapioca maltodextrin, salt, silicon dioxide, disodium | |
| phosphate, lactic acid, natural mixed tocopherols (Vitamin E). | |

Consumers have recognized the need for lower-sodium products with fewer additives. “On the market there is a growing demand from consumers and authorities for food produced without additives, including emulsifying salt, and currently especially sodium.” (Hougaard, A. B. et al., Production of Cheese Powder without Emulsifying Salt: Effect of Processing Parameters on Rheology and Stability of Cheese Feed, Annual Transactions of the Nordic Rheology Society (2013) 21:315-16). According to an October 2016 online article in Food Business News, in 2015, Euromonitor estimated global sales of clean label products to be $165 billion, with $62 billion of that being from North America alone (http://www.foodbusinessnews. net/articles/news_home/Business_News/2016/10/Clean_label_a_$180_billion_gl.aspx?ID={35B6F389-F481-4BF5-8DD1-9BAB90D5EA8B}&cck=1).

The FDA website states that the United States Centers for Disease Control and Prevention (CDC) “has compiled a number of key studies, which continue to support the benefits of sodium reduction in lowering blood pressure. In some of these studies, researchers have estimated that lowering U.S. sodium intake by about 40 percent over the next decade could save 500,000 lives and nearly $100 billion in healthcare costs.” It also states that the World Health Organization has recommended a global reduction in sodium intake and there are 75 countries working to reduce sodium intake—with 39 countries having already set target sodium levels for one or more processed foods.

Drying processes can be problematic because, for example, during the process of converting cheese to a cheese powder, some volatile flavor compounds may be lost. For example, buttery flavor components like diacetyl and dimethyl sulfide, both components being important to the natural flavor of cheese, can be lost at a rate of about 45% and about 30% respectively, during the spray drying process. Furthermore, inclusions are added to various natural and process cheeses to increase the number of types of cheeses and flavors that can be produced, but processes such as spray-drying are not as suitable for drying cheeses to which inclusions have been added. Therefore, current methods for large-scale production of cheese powders limit the types and flavors of cheese powders that can be produced.

Since one goal of the production of cheese powders is shelf-stability, water activity (a_{w}) is also an important consideration for the production of cheese powders. Water in food that is not bound to the food molecules is available to support the growth of microbes such as bacteria and molds. This unbound water determines the “water activity” of a product. The scale that is used for water activity ranges from 0 (dry) to 1.0 (pure water), with most foods having a water activity level within the range of 0.2 to 0.99. Decreasing the water activity of a food such as cheese, or cheese powder, can limit microbial growth. However, low water activity levels can also be associated with increased rates of lipid oxidation, producing an “off” flavor that is undesirable. Furthermore, water activity influences non-enzymatic browning, lipid oxidation, degradation of vitamins, enzymatic reactions, and protein denaturation. The likelihood of non-enzymatic browning increases with increasing a_{w}, reaching a maximum at a_{w} range 0.6 to 0.7. Generally, decreasing water activity hinders browning reactions. Lipid oxidation, on the other hand, has a minimum in the intermediate a_{w} range and increases at both high and low a_{w} values, although due to different mechanisms. This type of degradation results in the formation of highly objectionable flavors and odors, and the loss of fat-soluble vitamins.

All these factors must be taken into account when formulating methods for producing cheese powders. What are needed are methods for producing cheese powders that have reduced sodium, as compared to conventional spray-dried cheese powders that contain emulsifying salts and other sodium-containing additives, while overcoming some of the obstacles presented by various drying processes, such as the potential for producing undesirable flavor profiles, and maintaining sufficient shelf-stability of the powders in processed foods such as boxed dinners, flavored tortilla chips, flavored popcorn, and other similar food items.

### SUMMARY OF THE INVENTION

The invention relates to a method for producing cheese powder, the method comprising reducing the particle size of at least one freeze-dried cheese to produce a cheese powder without the addition of a functionally effective amount of one or more emulsifying salt. In various embodiments, the step of reducing the particle size of the at least one freeze-dried cheese comprises milling the freeze-dried cheese. In various embodiments, the step of reducing the particle size of the at least one freeze-dried cheese comprises grinding the freeze-dried cheese. The at least one freeze-dried cheese may, in various embodiments, comprise small blocks, cubes, or shreds, that have been freeze-dried.

The invention also relates to a method for producing cheese powder by a series of steps comprising freezing at least one cheese at a temperature of less than or equal to the triple point temperature of the cheese, drying the cheese to sublimate unbound water from the cheese and desorb bound water from the cheese, thereby producing at least one freeze-dried cheese, and reducing the particle size of the freeze-dried cheese to form a powder, the method being performed without the addition of a functionally effective amount of at least one emulsifying salt. In various embodiments of the invention, the step of drying the cheese can comprise a first drying phase for sublimation of unbound water and a second drying phase for desorption of bound water. In various embodiments, drying is performed under vacuum.

In various aspects, the step of freezing the cheese is performed by freezing the cheese at temperature of less than or equal to its triple point temperature. In various embodiments of the method, the step of reducing the particle size of the freeze-dried cheese to form a powder is performed by milling the freeze-dried cheese. In various aspects, the step of freezing the cheese at a temperature of less than or equal to the triple point of the cheese is performed for a period of from about 20 minutes to about 5 hours. In various embodiments, the first drying phase is performed under vacuum at a temperature that is slowly increased from the triple-point temperature (e.g., about −10 degrees Celsius) to about 30 degrees Celsius and the second drying phase held at about the temperature achieved at the end of the first phase. Both phases are allowed to proceed for a period of time that achieves the desired target moisture, which is about equal to or less than 10%.

### BRIEF DESCRIPTION OF THE DRAWINGS

FIG. 1 is a photograph of Pepper Jack cheese which has been shredded using a hand-held stainless-steel shredder. As the photograph illustrates, while the cheese size was easily reduced by the process of shredding, the seeds and pieces of pepper were not shredded, but instead broke loose from the cheese block during the shredding process and fell into or next to the pile of shredded cheese without being reduced in size during the process.

FIG. 2 is a photograph of a small mound of cheese powder made by the method of the invention.

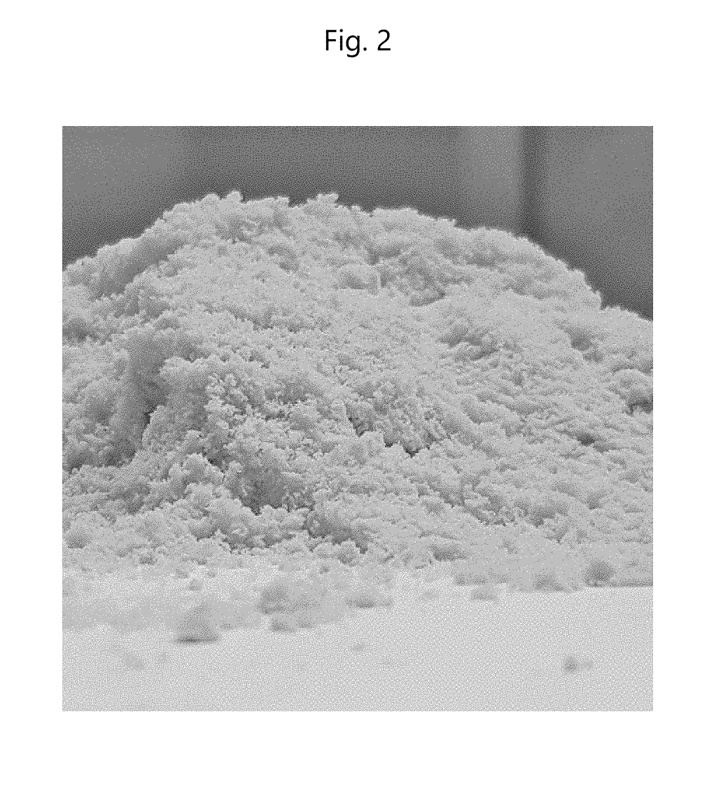

FIG. 3 is a photograph of a plastic bag containing cheese powder made by the method of the invention.

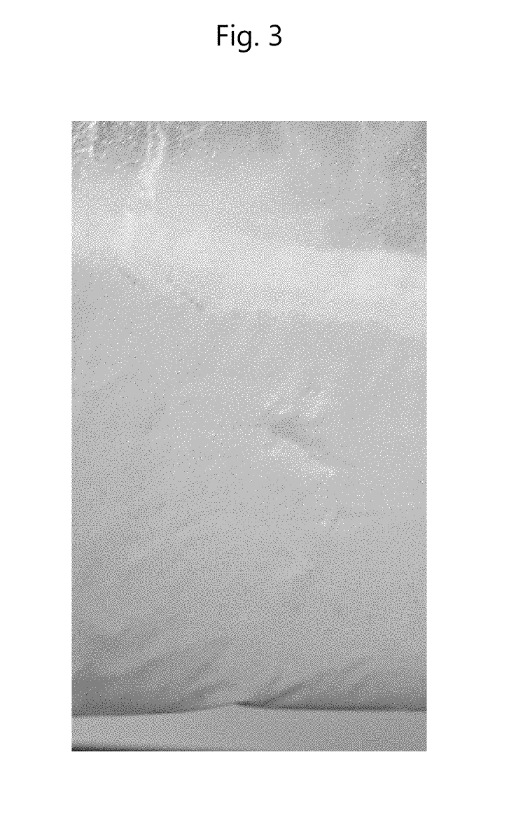

### DETAILED DESCRIPTION

The inventors have developed a method for producing cheese powder that does not require the addition of emulsifying salts, resulting in a lower-sodium alternative to the conventional spray-dried cheese. The inventive method comprises powdering freeze-dried cheese without the addition of a functionally effective amount of one or more emulsifying salts. As used herein, a “functionally effective amount” is an amount sufficient to modify the physicochemical properties of the cheese to which the emulsifying salt is added. That is, a “functionally effective amount” is distinguished from an amount of ingredient that may be added, or is otherwise present due to its presence in processing facilities, for example, at minimal amounts that would generally not be considered by one of skill in the art to measurably or detectably affect the physicochemical properties of the cheese in which it may be present.

The method can be performed, for example, by using already-prepared freeze-dried cheese and milling, grinding, or otherwise processing it to produce a powder, or it can be accomplished by making a freeze-dried cheese product which is then milled, ground, or otherwise processed to produce a powder of appropriate particle size for its intended use. Using freeze-dried cheese to form cheese powder has previously been disclosed by Missel (Missel, D., Selecting the Right Ingredients for Adding the Flavor of Cheese, https://www.naturalproductsinsider.com/articles/1996/08/selecting-the-right-ingredients-for-adding-the-fl.aspx, August 1996), and there are commercially-available freeze-dried cheese powders, but as Missel indicated in the article and the ingredients panels of the products also indicate, these freeze-dried cheese products have been made using one or more emulsifying salts—usually sodium phosphate or disodium phosphate—as “processing aids.” The inventors have discovered that cheese powder can be quite successfully made without the use of emulsifying salts, thereby producing cheese powders with decreased sodium levels, as compared to cheese powders previously made with emulsifying salts. Table 2 lists the ingredients in a cheese powder produced by the inventors, as well as the sodium content, using the method of the invention.

TABLE 2
Ingredients Listing-Cheese Powder Produce by Freeze Drying

| | Total Sodium |
|---|---|
| | (mg/28 g |
| | powder |
| Ingredients | product) |
| Cultured pasteurized milk, salt, enzymes | 288 |

As Izzo and Burton noted in U.S. Pat. No. 3,694,231, freeze-drying has been used to dry “soft cheese, such as cottage cheese, baker's cheese, Neufchatel cheese, farmer's cheese, buttermilk cheese, and the like, in the preparation of a dehydrated cheese product which on rehydration or reconstitution will physically resemble the original cheese” (Column 2, lines 16-21). However, they also indicate that “[w]hile freeze dried, reconstituted soft cheese has a texture similar to the original cheese, the flavor, color and aroma of the freeze dried product in its dehydrated form is totally unacceptable for immediate consumption and as a shelf stable cheese product” (Column 2, lines 22-27). Because it produces a product having such extended shelf-stability, freeze-drying has been used to produce shredded cheese for long-term storage. However, the primary purpose for cheese powder is to add the flavor of real cheese to products and recipes in which they are used. The inventors, however have successfully produced cheese powders having excellent flavor, as well as desirable color, texture, and reconstitution properties that make powders made by the method of the invention attractive lower-sodium alternatives to cheese powders produced by methods such as spray-drying that typically use emulsifying salts.

Although the invention encompasses the use of freeze-dried shredded cheese to form a powdered cheese product, the inventors have discovered that freeze-drying small blocks (e.g., cubes), of cheese produces dried cheese that is more easily comminuted by grinding, milling, etc., to produce a more uniform powder. The inventors also noted that lower-fat cheeses tend to be more easily processed and reconstitute better than full-fat cheeses. Also, full-fat cheeses to which one or more phospholipases have been added during the production process are also more easily processed and reconstituted than are full-fat cheese made without the use of phospholipase.

The method of the invention comprises the steps of freezing cheese at a temperature of less than or equal to the triple point temperature of the cheese, drying the cheese to produce sublimation of unbound water from the cheese, desorption of bound water from the cheese, the freezing and drying steps producing a freeze-dried cheese, and reducing the particle size of the freeze-dried cheese to form a powder. In various aspects, the step of freezing the cheese at a temperature of less than or equal to the triple point of the cheese is performed for a period of from about 20 minutes to about 5 hours. However, one of skill in the art can modify the freezing time according to the freezing method used. For example, freezing by direct contact with liquid nitrogen could produce the desired result almost instantaneously.

In various embodiments of the method, the drying step comprises two phases, the first drying phase being performed under vacuum at a temperature that is slowly increased from the triple-point temperature of the cheese (e.g., about −10 degrees Celsius) to about 30 degrees Celsius over a period of several hours. This drying phase may also be referred to as the “ramp” phase. During this ramp phase, ice crystals that have formed on the cheese as the result of freezing the cheese to at or below the triple point temperature will undergo sublimation to remove the “unbound” water from the cheese. The drying step can also comprise a second phase, which may be referred to as the “soak” phase, producing desorption of bound water from the cheese. In various embodiments of the method, both the ramp and soak phases (ie., the first drying phase and the second drying phase) are performed under vacuum and the vacuum pressure is 100-300 millitorr. In various embodiments, the first drying phase is performed under vacuum at a temperature that is slowly increased from the triple-point temperature (e.g., about −10 degrees Celsius) to about 30 degrees Celsius and the second drying phase held at about the ending temperature of the first phase. Both phases are allowed to proceed for a period of time that achieves the desired target moisture, which is about equal to or less than 10%. Furthermore, those of skill in the art will recognize that the ramp-and-soak processes may be repeated, so one could choose to perform one cycle or multiple ramp/soak cycles.

In various embodiments, the step of reducing the particle size of the freeze-dried cheese to form a powder is performed by grinding, milling, or other similar means known to those of skill in the art for reducing the particle size of a solid product to form a powder. Suitable equipment for grinding or milling, for example, can be purchased from various commercial equipment suppliers such as the Fitzpatrick Company (Elmhurst, Ill. USA), which makes the FitzMill® comminutor.

Natural cheese is generally formed into large blocks during cheese manufacturing (40-pound blocks being common in the industry). To facilitate the process of freeze-drying, the method can additionally comprise a first step of increasing the surface-area-to-volume ratio of the target cheese product. For example, one method by which the surface-area-to-volume ratio can be increased is by cutting or breaking a larger size portion of cheese (e.g., a 40-lb. block) to provide multiple smaller pieces. Smaller pieces can be made by cutting blocks of cheese to form from about 0.25- to about 1.0-inch cheese cubes, for example. Shredding can also be used to increase the surface-area-to-volume ratio so that the shreds can be frozen, dried, and further reduced in particle size to form a powder according to the method. Cutting to form slices can provide yet another option for increasing the surface-area-to-volume ratio. The inventors have found that the use of cubes of from about 0.25 to about 1.0 inch provides especially effective results, particularly for producing cheese powders to which anti-caking agents have not been added. However, although if shreds are used in spray-drying processes, for example, anti-caking agents are generally added in order to keep the shreds from sticking together and forming a clump, when cheese shreds are freeze-dried they may form clumps at some time during the process, but the clumps will generally readily dissociate to facilitate the milling and/or grinding process to produce powder without requiring the addition of anti-caking agents.

Once a desirable size is produced, the product is quickly frozen in order to avoid the formation of ice crystals, which can damage the structure of the cheese. The cheese is frozen below its triple point temperature, the triple point being the combination of temperature and pressure at which a substance can exist in equilibrium in the solid, liquid, and gaseous states. The triple points vary among the different types of cheeses. Therefore, the freezing point temperature can vary, depending on the age and type of cheese, but can readily be determined by one of skill in the art. For example, for Cheddar cheeses (from which most commercial cheese powders are made), the freezing point generally ranges from about −4.3 degrees Celsius to about −14.3 degrees Celsius.

The frozen cheese is then placed in a vacuum drying chamber. Generally, drying comprises two phases, which may be performed separately, but generally will overlap to at least some extent. The first part of the drying process consists sublimation of the unbound water from the cheese. The pressure in the drying chamber is lowered and heat is added to the system, which causes the ice to sublime. In a typical freeze-dryer, heat is primarily transferred through conduction, although convective and radiation heat transfer also contribute to drying. A condenser inside the dryer unit collects the water that has been removed from the product during the drying process. Heat is increased slowly in order to prevent damage to the structure of the cheese product.

The second drying phase removes additional water through desorption (removal of water molecules that are bound to the product). At this stage, the temperature is increased to help facilitate the removal of the remaining water. After the vacuum of the dryer is released, the dried cheese is removed from the freeze-dryer system and reduced in size to a powder. This can be done using a variety of methods, but one such method that is commonly used for producing powder from a solid food product is milling.

Milling can be accomplished in any of a variety of ways such as, for example, ball, attrition, hammer, cryomill, rotor-and-blade comminutor (e.g., FitzMill® comminutor, The Fitzpatrick Company, Elmhurst, Ill. USA) and/or other milling techniques, that can break the dry cheese down into a fine powder to correspond with the desired coarseness. Milling can be performed using starting material comprising dried shreds, dried cubes, slices, chips, chunks, and curds, for example. Starting material can therefore be selected from the group consisting of dried shreds, cubes, slices, chips, chunks, curds, and combinations thereof.

For Cheddar-based cheeses, for example, the inventors have demonstrated that it is not necessary to produce a completely dry cheese prior to milling. However, water activity should be reduced to about 0.6 or less in order to promote shelf stability of the cheese powder. The inventors have also found that a water activity of 0.3 or less produces a Cheddar cheese powder having a number of desirable properties. For Cheddar cheese, for example, this can be accomplished for large cubes (e.g., approximately 1-inch cubes), using a total drying time (i.e., first drying stage+second drying stage) of from about 23 to about 25 hours. Sufficiently reducing the water activity of the cheese but not completely drying it can produce more intense flavor and aroma. It can also produce a cheese powder that would be less prone to pulling water from other ingredients in products into which it might be incorporated as an ingredient.

Cheese powders made by the method of the invention can be used in a variety of products such as, for example, clusters, bars, snack mixes, layered snacks (e.g., cracker snacks), dips, sauces, etc., where they impart a natural cheese flavor that can, due to the elimination of the need to add emulsifying salts to produce the powder, contain significantly less sodium than similar products made with cheese powders containing emulsifying salt(s).

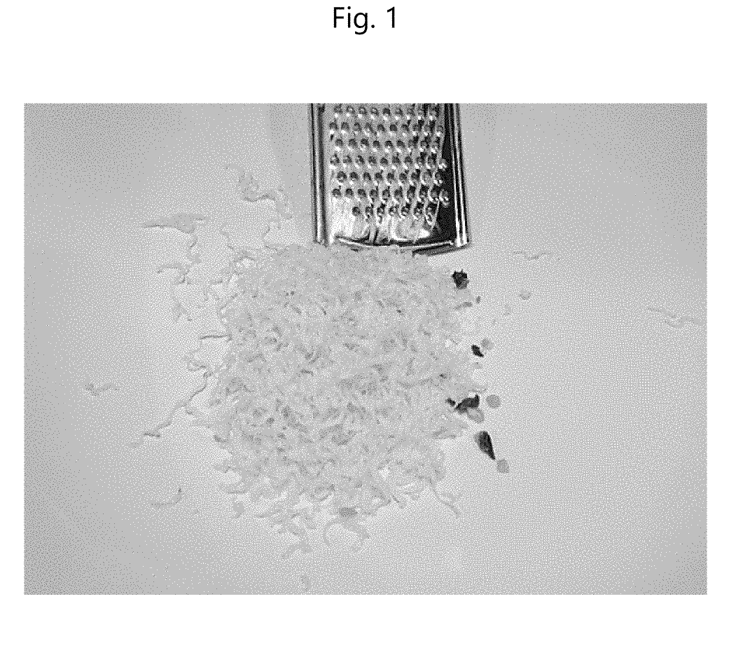

Cheeses containing inclusions such as, for example, dates, oranges, cranberries, truffles, mushrooms, sun-dried tomatoes, herbs, peppers, etc., have gained popularity in recent years. Due to the varied textures and compositions of such ingredients, however, they have not typically been incorporated into cheese powders that have been manufactured using the commonly-used process of spray-drying. As FIG. 1 illustrates, inclusions are generally not amenable to size-reduction by means such as shredding. The cheese can be readily reduced in size by shredding, while the seeds and other pieces of pepper from the Pepper Jack cheese tend to break away from the cheese block as it is being shredded, with no reduction in size of those pieces. This can be problematic in a process such as spray-drying, where the goal is to produce a liquid from which tiny droplets can be produced, then dried to give a powder of suitable conformity. Atomizers or spray nozzles used in spray-drying processes typically produce droplets ranging in size from 10 to 500 μm, with most applications being in the 100 to 200 μm diameter range, which cannot accommodate most types of inclusion ingredients, which are often dried fruits, vegetables (especially peppers), etc.

The option of adding inclusions allows a cheese processor to create base products, then differentiate those to form several different, added-flavor products from each base by the addition of inclusions at the start of the aging process. The present method facilitates the use of inclusion-based cheeses (ie., cheeses which inclusions have been added) for producing cheese powders. The addition of the inclusion(s) in the cheese during the aging process can add flavor(s) that disseminate(s) throughout the cheese, while producing more locally-intense flavor(s) where the inclusion(s) is/are deposited within the cheese. Using these types of cheeses to produce cheese powder using the method of the invention allows a cheese manufacturer to expand the flavor portfolio of cheese powders while generally maintaining their particle size consistency, which can be important for a variety of applications, and particularly important when cheese powders are used as coatings on foods such as chips, popcorn, and other snack items. Inclusions can be freeze-dried along with the cheese into which they have been incorporated. This freeze-dried cheese can then be milled, ground, or otherwise comminuted to produce a powder containing particles of both cheese and inclusion(s), providing a powdered cheese product having added flavor in the cheese particles, as well as additional similarly-sized particles of peppers, dried fruit, or other inclusion materials that add their flavor(s) to the powder.

When reconstituted and heated, a product made by the method of the invention can produce a “stringy” cheese which is closer to its natural cheese origins, while a commercially-available spray-dried cheese powder created a gel in a side-by-side comparison performed by the inventors. Also, the freeze-dried cheese powder has a more natural cheese taste, while the spray-dried cheese powder has a more process-cheese taste. The difference may be explained by the presence of the emulsifying salts, which are used in both process cheese manufacturing and in spray-drying to produce cheese powder from natural cheese. During the manufacture of natural cheese, salt is added to the curd after the desired pH is reached, helping to control fermentation and proteolysis by regulating starter cultures and enzymes. Salt also lowers the water activity of cheese, preventing the growth of undesirable microorganisms. Salt is therefore an important component of natural cheese. Process cheese, however, is produced by blending natural cheese(s) with emulsifying salts and other ingredients, then heating and mixing to form a homogeneous product with an extended shelf life. The emulsifying salts make process cheese flow when heated. Emulsifying salts also maintain homogeneity of the melted process cheese, while natural cheese tends to separate and expel the fats and oils from the casein matrix when heating to melting temperature. The ability of cheese to flow freely and to maintain homogeneity makes it easier to process using spray-drying, so emulsifying salts are added to natural cheese in order to produce spray-dried cheese, thereby increasing the sodium content of the cheese and giving it a more “process cheese taste.” The method of the invention does not require the use of emulsifying salts and therefore produces cheese powders with lower sodium levels than those of comparable spray-dried cheese products, as well as more natural cheese taste.

In a side-by-side comparison between the powdered freeze-dried cheese of the invention and a commercially-available spray-dried cheese powder, the inventors also noted that the spray-dried cheese powder had small brown spots that appeared to be scorched product, which may be explained by the higher temperatures required to produce the spray-dried cheese powder, while the powder produced from freeze-dried cheese has no noticeable browning.

Non-enzymatic browning, caused by the Maillard reaction, can cause the formation of chemically-stable but undesirable chemical derivatives in cheese powder. As noted above, brown spots were present in the spray-dried cheese but not noted in the freeze-dried cheese powder of the invention. Erbay et al tested the parameters for spray-drying and their effects on the final cheese powder. (Erbay, Z. et al Optimization of spray drying process in cheese powder production. Food and Bioproducts Processing (2015) 93: 156-165.) They noted that the outlet drying temperature was the most significant process parameter that affected the browning index (BI), with outlet drying temperatures less than 80° C. being recommended to obtain low BI values. To produce lower FFC values, Erbay et al. noted that low inlet and high outlet drying temperatures with high atomization pressure were better choices during the spray-drying process. Overall recommendations in the industry, however, suggest that the inlet temperature must be as high as possible in order to achieve a final product with low residual moisture, and increasing the feed flow rate lowers the outlet temperature, which can also result in product with higher residual moisture content. Therefore, one of the challenges in spray-drying cheese powder is keeping FFC values lower while also keeping residual moisture levels low enough. The most significant process parameter Erbay et al. noted for the solubility index was outlet drying temperature, with powders produced at lower outlet drying temperatures generally being more soluble.

According to Izzo and Burton, “it is essential that the temperature of the cheese never be allowed to rise above about 24° C., preferably 21° C., during the drying operation. High temperatures during the drying operation have been found to unfavorably affect the quality of the final product. Specifically, high temperatures drive off flavor and promote oiling off thereby retarding drying and causing the cheese particles to cake. Oil on the surface of the cheese particles causes development of off-flavors and rancidity and retards dehydration.” (U.S. Pat. No. 3,694,231, Column 4, lines 52-62.) The drying temperature of the method of the present invention does exceed 24° C., however, and the inventors have not noted any of these issues in their powdered cheese product.

The temperatures to which freeze-dried cheese powders produced by the method of the invention must be subjected during manufacturing will be significantly lower than the temperatures required for spray-drying. Based on the inventors' current observations of their product vs a spray-dried product, particularly in view of the observations made by Erbay et al., it is reasonable to conclude that major processing concerns for cheese powder production, such as decreasing non-enzymatic browning, could be better addressed by producing cheese powders by the method of the invention, rather than by spray-drying.

The invention has been described as “comprising” certain steps and ingredients, which those of skill in the art will understand may also be considered to “consist of” or “consist essentially of” those steps and/or ingredients. Therefore, where the term “comprising” is used and the invention is intended to be more narrowly defined, the terms “consisting of” or “consisting essentially of” may also be used to describe the invention. The invention may also be further described by means of the following non-limiting example.

### Example

Cheddar cheese was used as a starting product (moisture range 35.5 to 39%). It was then cut to provide ½-inch cubes, which were stored in clear plastic bags under refrigeration until ready for use in the freeze-drying process. Seven pounds of cheese were loaded onto each freeze-dryer tray, and the freeze-dryer temperature was set at about −10 degrees Celsius, to pre-chill for a period of at least 10-20 minutes. Loaded metal trays were placed into a 1000 L freeze-dryer by being placed on chilled shelves within the dryer. Freezing was them performed for a period of about 3 hours. The vacuum was then set at a constant 0.2 mbarr/150 mtorr while the cubes were slowly heated from −10 degrees Celsius to 30 degrees Celsius over a 12-hour period to remove unbound water by sublimation. After the ramp phase, the temperature of the freeze-dryer was held at 30 degrees Celsius for 12 hours (i.e., the “soak phase”), during which bound water was released from the cheese matrix to further dry the cheese to a shelf-stable water activity level 0.1 to 0.3. The dryer vacuum was released, leaving a cheese product with a moisture level of less than 4 percent. Cheese cubes were ball-milled to reduce the dried cubes to a powder containing particle sizes of about 210 μm. The ingredients and sodium content of the resulting cheese powder are listed in Table 2 above.

What is claimed is:

1. A method for producing cheese powder, the method comprising reducing the particle size of at least one freeze-dried cheese to produce a cheese powder without the addition of a functionally effective amount of one or more emulsifying salt.

2. The method of claim 1 wherein the step of reducing the particle size of at least one freeze-dried cheese comprises milling the freeze-dried cheese.

3. The method of claim 1 wherein the step of reducing the particle size of at least one freeze-dried cheese comprises grinding the freeze-dried cheese.

4. The method of claim 1 wherein the cheese powder comprises a mixture of more than one natural cheese.

5. A method for producing a cheese powder from an inclusion-based cheese, the method comprising reducing the particle size of at least one freeze-dried inclusion-based cheese to produce a cheese powder, the cheese powder comprising particles of both the cheese and the at least one inclusion.

6. The method of claim 5 wherein the step of reducing the particle size of the at least one freeze-dried inclusion-based cheese comprises milling the freeze-dried cheese.

7. The method of claim 5 wherein the step of reducing the particle size of the at least one freeze-dried inclusion-based cheese comprises grinding the freeze-dried cheese.

8. The method of claim 5 wherein the cheese powder comprises a mixture of more than one natural cheese.

9. A method for producing cheese powder, the method comprising the steps of (a)
freezing at least one cheese at a temperature of less than or equal to the triple point temperature of the cheese;
(b) drying to produce sublimation of unbound water from the cheese and desorption of bound water from the cheese, to produce a freeze-dried cheese; and
(c) reducing the particle size of the freeze-dried cheese to form a powder.

10. The method of claim 9 wherein drying is performed under vacuum.

11. The method of claim 9 wherein the step of freezing the cheese at a temperature of less than or equal to the triple point of the cheese is performed for a period of from about 20 minutes to about 5 hours.

12. The method of claim 9 wherein the step of reducing the particle size of the freeze-dried cheese to form a powder is performed by a method selected from the group consisting of milling, grinding, and combinations thereof.

13. The method of claim 9 wherein the step of reducing the particle size of the freeze-dried cheese to form a powder is performed by a method selected from the group consisting of ball milling, attrition milling, hammer milling, cryomilling, rotor-and-blade milling, and combinations thereof.

14. A clean-label low-sodium natural cheese powder produced by reducing the particle size of at least one freeze-dried natural cheese by a method selected from the group consisting of grinding, milling, and combinations thereof, the cheese powder containing no functionally effective amounts of emulsifying salts, anti-caking agents, or other compounds which add additional sodium to the natural cheese powder.

15. The cheese powder of claim 14 wherein the grinding is selected from the group consisting of ball milling, attrition milling, hammer milling, cryomilling, rotor-and-blade milling, and combinations thereof.

16. The cheese powder of claim 14 wherein the at least one freeze-dried cheese is at least one inclusion-based cheese.

17. A cheese powder produced by a method comprising the steps of
(a) freezing at least one cheese at a temperature of less than or equal to the triple point temperature of the cheese;
(b) drying the cheese to sublimate unbound water from the cheese and desorb bound water from the cheese, thereby producing a freeze-dried cheese; and
(c) reducing the particle size of the freeze-dried cheese to form the cheese powder.

18. The cheese powder of claim 17 wherein the at least one cheese is a natural cheese.

19. The cheese powder of claim 17 wherein the at least one cheese is selected from the group consisting of Cheddar, Mozzarella, Monterey Jack, Colby, Gouda, and combinations thereof.

20. The cheese powder of claim 17 wherein the at least one cheese is at least one inclusion-based cheese.
